(19) United States
(12) Patent Application Publication
(10) Pub. No.: US 2021/0141907 A1
(43) Pub. Date: May 13, 2021

(54) METHOD AND DEVICE FOR PATCHING VULNERABILITY OF BINARY

(71) Applicant: KOREA INTERNET & SECURITY AGENCY, Jeollanam-do (KR)

(72) Inventors: Hwan Kuk Kim, Jeollanam-do (KR); Tae Eun Kim, Jeollanam-do (KR); Dae Il Jang, Jeollanam-do (KR); Han Chul Bae, Jeollanam-do (KR); Jong Ki Kim, Jeollanam-do (KR); Jee Soo Jurn, Jeollanam-do (KR); Geon Bae Na, Jeollanam-do (KR)

(21) Appl. No.: 16/935,170

(22) Filed: Jul. 21, 2020

(30) Foreign Application Priority Data
Nov. 12, 2019 (KR) 10-2019-0144010

(51) Int. Cl. G06F 21/57; G06F 8/65; G06F 21/52

(52) U.S. Cl. CPC G06F 21/577; G06F 2221/033; G06F 21/52; G06F 8/65

(57) ABSTRACT

A method for patching a vulnerability of a binary performed on a computing device is provided. The method comprises, inserting a patch code block in a target binary, and replacing at least some instructions in an area where the vulnerability exists in the target binary with a first instruction to jump to the patch code block, wherein the patch code block comprises a second instruction to resolve the vulnerability, and a third instruction to jump to a fourth instruction next to the first instruction replaced in the area where the vulnerability exist

### CROSS-REFERENCE TO RELATED APPLICATION

This application claims priority from Korean Patent Application No. 10-2019-0144010 filed on Nov. 12, 2019 in the Korean Intellectual Property Office, and all the benefits accruing therefrom under 35 U. S. C. 119, the contents of the application in its entirety is herein incorporated by reference.

### BACKGROUND

### 1. Technical Field

The present disclosure relates to a method and device for patching a binary in which a vulnerability exists. More specifically, the present disclosure relates to a method and device for directly inserting patch code that supplement a vulnerability of a binary into the binary.

### 2. Description of the Related Art

Various vulnerabilities may exist in a program binary. For example, various types are known, including use of an uninitialized variable, buffer overflow, integer overflow, memory exception, malformed-input, race condition, symbolic link, null pointer references, etc. Due to the vulnerability, some functions of the binary may be modified without permission for an inappropriate purpose, and a system in which the binary is executed may cause security problems. Therefore, the vulnerability of the binary running on security-critical systems will need to be resolved quickly and accurately. Also, if such a vulnerability exists in the binary, an unexpected error occurs at the time of execution of the binary. For example, use of an uninitialized variable may result in an unexpected result value, or a control flow of a program may proceed to a wrong path. Further, segmentation faults or the like frequently occur due to omission of an exception regarding buffer overflow.

In the process of developing a program, generally, one logically analyzes and verifies contents of source code of a program, or one uses a debugging program to set breakpoints in the source code of the program where there is a possibility of vulnerability. Then, when the execution is suspended according to the break point during the execution of the program, the vulnerability of the program is identified by observing the execution environment of the program. Then, the vulnerability of the program may be removed by rebuilding the program by modifying source code so that the identified vulnerability is removed.

However, after a program is developed, especially if a third party who is not the program's developer analyzes and patches the program's vulnerability, vulnerability analysis and patching are mostly performed on program binaries in environments where source code cannot be obtained. Therefore, the method for removing the vulnerability by modifying the source code may not be utilized. Therefore, it would be useful for a technique for directly modifying and patching a binary in which a vulnerability exists.

### SUMMARY

Aspects of the present disclosure provide a method and device for patching a binary in which a vulnerability exists.

Aspects of the present disclosure also provide a method and device for directly inserting patch code that supplement a vulnerability of a binary into the binary.

Aspects of the present disclosure also provide a method and device for effectively patching a vulnerability of a binary due to the use of an uninitialized variable.

Aspects of the present disclosure also provide a method and device for effectively patching a vulnerability of a binary due to null pointer reference.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, a method for patching a vulnerability of a binary performed on a computing device is provided. The method comprises, inserting a patch code block in a target binary, and replacing at least some instructions in an area where the vulnerability exists in the target binary with a first instruction to jump to the patch code block, wherein the patch code block comprises a second instruction to resolve the vulnerability, and a third instruction to jump to a fourth instruction next to the first instruction replaced in the area where the vulnerability exists.

According to an aspect of the present disclosure, a method for patching a vulnerability of a binary performed on a computing device is provided. The method comprises, inserting a patch code block in a target binary, and replacing at least some instructions in an area where the vulnerability exists in the target binary with a first instruction to jump to the patch code block, wherein the patch code block comprises a second instruction to determine whether a crash occurs at runtime.

According to an aspect of the present disclosure, a device for patching a vulnerability of a binary is provided. The device comprises a patch area generation unit, and a patch execution unit, wherein the patch area generation unit is configured to search for a free area among text areas of a target binary, add an area for a patch code to the target binary based on a size of the free area being less than a size of the patch code, and determine a patch area into which the patch code is to be inserted in the target binary, wherein patch execution unit is configured to insert the patch code in the patch area, and replace at least some instructions in an area where the vulnerability exists in the target binary with a first instruction to jump to the patch area, wherein the patch code comprises a second instruction to resolve the vulnerability, and a third instruction to jump to a fourth instruction next to the first instruction replaced in the area where the vulnerability exists.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a view for explaining an exemplary environment to which embodiments of the present disclosure may be applied.

FIG. 2 is a view for explaining a method for patching a vulnerability of a binary according to an embodiment of the present disclosure.

FIG. 3 is a view for explaining an exemplary method for securing a patch area in a target binary in the embodiment described with reference to FIG. 2.

FIGS. 4A and 4B are views for explaining an example binary having a vulnerability using an uninitialized variable.

FIG. 5 is a view for explaining changes in a binary before and after patching the binary having a vulnerability using an uninitialized variable by a method according to some embodiments of the present disclosure.

FIG. 6 is a pseudo-code for explaining an operation of a program for patching a vulnerability using an uninitialized variable by a method according to some embodiments of the present disclosure.

FIG. 7 is a view for explaining an exemplary binary having a null pointer reference vulnerability.

FIG. 8 is a view for explaining changes in a binary before and after patching the binary having a null pointer reference vulnerability by a method according to some other embodiments of the present disclosure.

FIG. 9 is a view for explaining a device for patching a vulnerability of a binary according to another embodiment of the present disclosure.

### DETAILED DESCRIPTION OF THE EMBODIMENTS

Hereinafter, embodiments of the present disclosure will be described with reference to the attached drawings. Advantages and features of the present disclosure and methods of accomplishing the same may be understood more readily by reference to the following detailed description of embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will be defined by the appended claims.

In adding reference numerals to the components of each drawing, it should be noted that the same reference numerals are assigned to the same components as much as possible even though they are shown in different drawings. In addition, in describing the present disclosure, based on it being determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing embodiments and is not intended to be limiting of the present disclosure. In this specification, the singular also includes the plural unless specifically stated otherwise in the phrase.

In addition, in describing the component of this present disclosure, terms, such as first, second, A, B, (a), (b), can be used. These terms are for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, some embodiments of the present disclosure will be described in detail with reference to the accompanying drawings.

First, with reference to FIG. 1, a series of processes for patching a vulnerability of a binary will be described.

First, vulnerability identification and patch target binaries 10 may be given, and vulnerability area search or a vulnerability search process 110 for the target binaries 10 is performed. The vulnerability search 110 may be performed using various conventional techniques such as fuzzing, symbolic execution, and hybrid fuzzing combining them.

The fuzzing is a method that generates a situation where a program crashes by repeatedly generating arbitrary values (test cases) and inputting them into a target program. The symbol execution is a method for specifying an input value of a target program as a symbol and finding a value that may reach a path of the program's vulnerability. The hybrid fuzzing is a technique that combines fuzzing and symbolic execution. It is a way to use fuzzing in shallow paths to quickly explore vulnerabilities, and to search for vulnerabilities by using symbolic execution based on path search no longer being possible.

By the vulnerability search process 110, an address of an area where the vulnerability was found in the target binary, an address of an instruction causing the vulnerability, or a name of a function where the vulnerability was found may be identified, and information on crash caused by the vulnerability may be written.

Next, a process of analyzing 120 a cause of the vulnerability in FIG. 1 will be described. The process 120 of analyzing the cause of the vulnerability is performed based on information on an area where the vulnerability was found and crash information calculated as a result of performing the vulnerability search 110 for the target binary 10. There may be many different causes and types of vulnerabilities in binaries. From 2010 to 2015, about 80,000 security vulnerabilities (CVEs) were registered in the National Vulnerability Database (NVD), which is a vulnerability database, and it has been increasing continuously in recent years. Some of typical types of various security vulnerabilities may be buffer overflow or integer overflow types that store data exceeding the allocated storage space, a variable type error type, a vulnerability type used without initializing a variable, a vulnerability referencing a null pointer, etc. The cause of the vulnerability may be analyzed by various techniques.

Next, a process 130 of patching to remove vulnerabilities in FIG. 1 will be described. As described above, according to the types and causes of various vulnerabilities, various patch types and patch application methods for removing the vulnerabilities may be selected. For example, a patch for various purposes such as a variable initialization patch, a parameter verification or change patch of a function, and a control flow change patch may be selected depending on the cause of the vulnerability. In addition, for example, various patching methods such as a patch that changes an assembly instruction of a target binary, a patch that changes an instruction that call an unsafe library function in a target binary, and a runtime memory patch that causes a security library to be loaded at execution time of a target binary, or the like may be selected. Embodiments of the present disclosure may be applied to the process of the patch 130 for removing the vulnerability.

So far, it has been described with reference to FIG. 1 that embodiments of the present disclosure may be applied to the series of processes of patching the vulnerability of the binary. Hereinafter, a method and device for patching a vulnerability of a binary according to various embodiments of the present disclosure will be described in detail with reference to FIGS. 2 to 9.

FIG. 2 is a view for explaining a method for patching a vulnerability of a binary according to an embodiment of the present disclosure. The method for patching the vulnerability of the binary according to the present embodiment may be performed on a computing device. Hereinafter, based on a subject for each operation included in the method for patching the vulnerability of the binary according to the present embodiment being omitted, the subject may be interpreted as a computing device.

First, in step S210, the target binary 10 is loaded, and information on a found vulnerability is identified. The information on the vulnerability may include the type of vulnerability and an address of an area where the vulnerability occurred. The information on the vulnerability may be provided as a result of performing the process of searching 110 for the vulnerability and the process of analyzing 120 the cause of the vulnerability as shown in, for example, FIG. 1.

In step S220, an area into which patch code is to be inserted is secured in the target binary 10, and the address of the area is identified. According to some embodiments of the present disclosure, the entire patch code for removing the vulnerability may be integrated into a file of the target binary 10. Further, according to some embodiments of the present disclosure, a free space present in the target binary 10 is identified and may be used for inserting the patch code. Further, according to some other embodiments of the present disclosure, an additional area for the patch code may be generated in the target binary 10. A method for securing an area in which patch code is to be inserted in the target binary 10 will be described in more detail with reference to FIG. 3.

First, in step S222, a code section (.text) in the target binary 10 is searched. For example, a free space in the code section (.text) of the target binary 10 is searched. Here, the free space includes spaces filled with, for example, NOP commands. The NOP command may correspond to opcodes such as 0x90, 0x00, 0x00000000, depending on the architecture of the CPU.

In step S224, a size of the free space found as a result of the search and a size of a patch code block may be compared with each other. Based on a free space of the size sufficient to insert a patch code block being found, the found free space is determined as an area into which the patch code block is to be inserted (step S226). In addition, an address where the free space starts is identified, and may be used in step S230 of FIG. 2 to be described later.

If the code section (.text) in the target binary 10 is searched, and based on no free space being found or the size of the found free space is smaller than the size of the patch code block, it proceeds to step S228.

In step S228, an additional area for the patch code block is generated in the target binary 10. In some embodiments, a new section may be generated for the additional area in the target binary 10. In some other embodiments, the additional area may be generated in a suitable space among existing sections in the target binary 10. In addition, in order to reflect the generation of the additional area, a new header may be added in the file of the target binary 10, or some of existing headers in the file of the target binary 10 may be modified. The header includes a section header, a program header, or PHDR. The additional area generated in step S228 is determined as an area into which the patch code block is to be inserted (step S226). In addition, an address where the additional area starts is identified, and may be used in step S230 of FIG. 2 to be described later.

Referring again to FIG. 2, an operation after the area in which the patch code is to be inserted in the target binary 10 is secured will be described.

In step S230, a patch code block including a patch code for removing the vulnerability is inserted into the target binary 10. Here, the area within the target binary 10 secured in step S220 described above may be used. For example, the patch code block may be inserted into a free space of a code section in the target binary 10 or a space additionally generated for inserting a patch code block in the target binary 10. In some embodiments, the patch code is machine code written in machine language, and the patch code may be written in the area in the file of the target binary 10.

In some embodiments, based on the vulnerability to be removed being a vulnerability due to the use of an uninitialized variable, the patch code may include instructions for initializing values stored in a memory space allocated to uninitialized variables. In some other embodiments, based on the vulnerability to be removed being a vulnerability due to the reference of a null pointer, the patch code may include instructions for determining whether a value of a register or operand that may store a null value (NULL) is a null value or 0, and depending on the result, stopping execution of the target binary 10 while outputting an appropriate error message, or continuously executing the target binary 10.

In addition, the patch code includes instructions for causing a control flow of the binary 10 to return to a point where the vulnerability occurred, following instructions for performing the operations as described above. The instruction for returning to the point where the vulnerability occurred includes an opcode indicating a jump command and an address of the point where the vulnerability occurred. For the address of the point where the vulnerability occurred, the information identified in step S210 described above may be used.

In step S240, at least a part of an instruction in the area in which the vulnerability is found in the target binary 10 is replaced with a new instruction. The new instruction includes an instruction to jump to the patch code block. The instruction to jump to the patch code block includes an opcode indicating a jump command and an address of the patch code block. Machine code corresponding to the instruction to jump to the patch code block may be written in a location where an instruction to be replaced in the area in which the vulnerability is found is written, in the file of the target binary 10.

Although FIG. 2 shows that step S240 is performed after step S230 is performed, the methods according to various embodiments of the present disclosure are not limited to such an order. In other words, in some embodiments, after an operation of replacing the vulnerable area instruction in the target binary 10 with the instruction to jump to the patch code block, an operation of inserting the patch code block in the target binary 10 may be performed.

In step S250, a binary to which a patch is applied to the target binary 10 is stored or transmitted through steps S210 to S240 described above. In some embodiments, the patched binary may be stored as a separate file from the file of the target binary 10. In some other embodiments, the patched binary may replace the file of the target binary 10. In some other embodiments, the patched binary may be transmitted over a network to another computing device.

So far, with reference to FIGS. 2 and 3, the method for patching the vulnerability of the binary according to an embodiment of the present disclosure has been described. According to the present embodiment, a patch code for removing a vulnerability of the target binary 10 is inserted into a file of the target binary 10. Removal of a vulnerability existing in the target binary 10 may be completed without relying on another binary linked with the target binary 10 or a library function called by the target binary 10 in execution. Also, according to the present embodiment, a patch code is inserted by utilizing a free space in the file of the target binary 10 as much as possible. It is possible to remove the vulnerability of the target binary without causing an unnecessary increase in a size of the file of the target binary 10. In addition, since the structure of the file of the target binary 10 is maintained, it is possible to ensure high compatibility of the patched binary file. In addition, by utilizing a space in a code section (.text) of the file of the target binary 10 for patch code insertion, a control flow may also have a performance advantage that it may quickly move and return to a patch code block based on the target binary 10 being executed.

Hereinafter, a method for patching a binary having a vulnerability of using an uninitialized variable according to some embodiments of the present disclosure will be described with reference to FIGS. 4 to 6. In addition, with reference to FIGS. 7 to 9, a method for performing a patch for a binary having a vulnerability due to the access of an abnormal memory, for example, a vulnerability of referring to a null pointer, will be described.

FIG. 4A is example code for explaining an exemplary program binary having a vulnerability of using an uninitialized variable. A function ‘foo’ called in a program of FIG. 4A declares a total of 7 integer type local variables (a, b, c, d, e, f, g), but no value is allocated to the local variables. In addition, the function performs a command (printf) to output a value stored in the local variables.

FIG. 4B is a view showing an exemplary result of compiling and executing the example code shown in FIG. 4A. As shown in FIG. 4B, based on the program of FIG. 4A being executed, unexpected values may be output as values of the local variables of the ‘foo’ function. Using uninitialized variables like this may cause a potential security threat. It is desirable to remove the vulnerability of using the uninitialized variables in the program.

FIG. 5 is a view for explaining changes in the binary before and after performing a patch that removes the vulnerability due to the use of uninitialized variables, for the binary of the program shown in FIG. 4a, by a method according to some embodiments of the present disclosure. It is noted that contents of a binary 500 before patching a vulnerability and a binary 520 after patching a vulnerability may be described in the form of assembly code in FIG. 5 for convenience of understanding, but may be actually written in the form of machine language (machine code).

The binary 500 before patching the vulnerability in FIG. 5 includes a vulnerable function block 510 corresponding to a function (the ‘foo’ function) containing the vulnerability. The vulnerable function block 510 includes a prologue 511 and a body 512.

The prologue 511 is an area including instructions for setting a stack frame of the ‘foo’ function and securing a memory space for local variables declared in the ‘foo’ function. For example, the prologue 511 includes an instruction to store a value of a base pointer register on a stack (push % ebp), an instruction to store a value stored in the stack pointer register in the base pointer register (mov % esp, % ebp), and an instruction to secure a memory space (stack) for the local variables declared in the ‘foo’ function by subtracting a memory address indicated by the stack pointer register by 0x28, for example (sub 0x28, % esp).

The body 512 includes instructions corresponding to operations performed by the ‘foo’ function (e.g., a printf statement in the example code shown in FIG. 4A).

The binary 520 after patching the vulnerability in FIG. 5 is a binary in which a patch code block 540 is inserted into the binary 510 before patching the vulnerability, and that includes a block 530 in which contents of the vulnerable function block 510 of the binary 510 before patching the vulnerability may be modified.

In more detail, first, the patch code block 540 is inserted into the binary 520 after patching the vulnerability. An area into which the patch code block 540 is inserted may be an free space existing in a code section (.text) of the binary 510 before patching the vulnerability, or an area generated additionally in the binary 510 before patching the vulnerability, determined by the method described with reference to FIG. 3.

The patch code block 540 includes a block 541 in which instructions of the prologue 511 of the vulnerable function block 510 may be copied and written as it is. Also, the patch code block 540 includes a block 542 in which instructions for removing a vulnerability of the ‘foo’ function may be written.

For example, the block 542 includes instructions for initializing the local variables of the ‘foo’ function. In some embodiments, instructions to remove the vulnerability of the ‘foo’ function include instructions to store, for example, a value of 0 in a memory space from a memory address indicated by the base pointer register to a memory address indicated by the stack pointer register. In other words, an initial value (e.g., 0) is stored in the local variable of the ‘foo’ function. The vulnerability existing in the ‘foo’ function may be removed. Also, an instruction to jump to a block 532 is written in the block 542. The block 532 will be described later.

As described above, the binary 520 after patching the vulnerability includes the block 530 in which the contents of the vulnerable function block 510 of the binary 510 before patching the vulnerability may be modified. The block 530 includes a block 531 in which the instructions of the prologue 511 of the vulnerable function block 510 may be replaced with new instructions, and a block 532 including instructions of the body 512 of the vulnerable function block 510 as it is.

The block 531 includes an instruction to jump to the patch code block 540 instead of the instructions of the prologue 511. In some embodiments, an appropriate number of NOP instructions may be written to the block 531 so that the block 531 has the same size as the prologue 511.

Meanwhile, the instructions of the body 512 of the vulnerable function block 510 may be written in the block 532 as it is. For example, the instructions corresponding to the operations performed by the ‘foo’ function (e.g., the printf statement in the example code shown in FIG. 4A) may be written in the block 532.

So far, instructions written in the binary before and after performing a patch that removes the vulnerability due to the use of uninitialized variables, for the binary of the program shown in FIG. 4a, by a method according to some embodiments of the present disclosure, may be described. Hereinafter, an execution flow of the binary 520 after patching the vulnerability will be described.

First, based on the ‘foo’ function being called in a main( ) function of the program shown in FIG. 4A, a control flow moves to block 530. Then, the control flow is moved to the patch code block 540 by a jump instruction written in the block 531. Instructions written in the block 541 may be instructions corresponding to the prologue of the function ‘foo’ as described above. A stack frame of the ‘foo’ function is set by the instructions written in the block 541, and a memory space for the local variables declared in the ‘foo’ function is secured. Subsequently, the local variables of the ‘foo’ function may be initialized by instructions written in block 542. In other words, an initial value (e.g., 0) is stored in the local variable of the ‘foo’ function, thereby eliminating a vulnerability existing in the ‘foo’ function. In addition, the control flow is moved to the block 532 by the jump instruction written in the block 542. The operations performed by the ‘foo’ function (e.g., the printf statement in the example code shown in FIG. 4A) may be performed by the instructions written in the block 532.

FIG. 6 is an exemplary pseudo diagram illustrating a patch program for patching a binary of a program having a vulnerability of using an uninitialized variable, such as the example code shown in FIG. 4A, by a method according to some embodiments of the present disclosure. For example, a pseudo code of a patch program that generates the binary 520 after patching the vulnerability in FIG. 5 by modifying the binary 500 before patching the vulnerability in FIG. 5 is shown in FIG. 6.

Referring to FIG. 6, first, a file of a binary to be patched is opened. Subsequently, a file descriptor is moved to a prologue of a vulnerable function in the binary to be patched. An address of the vulnerable function may be, for example, provided as a result of performing the process of searching 110 the vulnerability the process of analyzing 120 the cause of the vulnerability shown in FIG. 1, and then be provided as an input value to the patch program.

Subsequently, instructions written in machine code in the prologue of the vulnerable function may be read and stored in a variable ‘b_prologue,’ and the file descriptor is moved back to a location of the prologue.

Subsequently, a first jump instruction is written in machine code at the location of the prologue. Here, the first jump instruction is an instruction to jump to an address where a patch code block is inserted. The address where the patch code block is inserted may be an address of a free space existing in a code section (.text) of the binary 510 before patching the vulnerability, or an area additionally generated in the binary 510 before patching the vulnerability, for example, as determined by the method described with reference to FIG. 3. The address may be identified in advance by a code preceding the pseudo codes shown in FIG. 6.

Subsequently, the file descriptor is moved to the address where the patch code block is inserted, and the machine codes of the prologue of the vulnerable function stored in the variable ‘b_prologue’ may be written to the address.

Subsequently, instructions for initializing the local variables of the vulnerable function may be written in machine code. For example, the instructions may be, for example, instructions that store a value of 0 in a memory space from a memory address indicated by a base pointer register to a memory address indicated by a stack pointer register. In other words, the instructions may be instructions to remove the vulnerability of the target binary.

Then, a second jump instruction is written in machine code. Here, an address of a destination of the second jump instruction may be determined based on an address in which the instructions of the prologue portion of the vulnerable function may be written in the target binary. For example, an address immediately following the address in which the instructions of the prologue of the vulnerable function may be written may be used as an operand indicating the destination of the second jump instruction.

Through the patch program as described above, a vulnerability may be removed from a binary having a vulnerability of using an uninitialized variable.

So far, the method for patching the binary having the vulnerability of using the uninitialized variable according to some embodiments of the present disclosure is described with reference to FIGS. 4 to 6. Hereinafter, with reference to FIGS. 7 to 9, a method for performing a patch for a binary having a vulnerability due to the access of an abnormal memory, for example, a vulnerability of referring to a null pointer, according to some other embodiments of the present disclosure will be described.

FIG. 7 is example code for explaining an exemplary program binary having a vulnerability of referring to a null pointer. A function ‘foo2’ called in the program of FIG. 7 declares a pointer variable ‘data’ that stores an address of a memory for storing ‘double’ type data, but does not allocate a memory space indicated by the pointer variable, and does not store an address of the memory space in the pointer variable. In other words, the pointer variable ‘data’ is used without being initialized.

If binary code compiled with the example code shown in FIG. 7 is executed, unexpected strings may be output. On the other hand, in the case of applying a patch that initializes an uninitialized local variable to the binary by the method for patching described with reference to FIGS. 4 to 6, the pointer variable ‘data’ is initialized and a 0 or NULL value will be stored in the pointer variable ‘data.’ Based on the patch-applied binary being executed, it refers to a memory address indicated by the pointer variable ‘data’ in which the NULL value is stored, and, a segmentation fault may occur and execution of the binary may be abnormally stopped.

Hereinafter, a method for patching a binary having a vulnerability due to abnormal memory access will be described according to some other embodiments of the present disclosure. In the following description, a method for patching a vulnerability due to the reference of a null pointer among vulnerabilities caused by abnormal memory access will be described. However, it is noted that a method to be described later may also be applied to patch other types of vulnerabilities caused by abnormal memory access (e.g., buffer over-write, buffer under-write, buffer over-read, buffer under-read, etc.).

FIG. 8 is a view for explaining changes in a binary before and after performing a patch that removes a vulnerability caused by the reference of a null pointer by a method according to some embodiments of the present disclosure.]It is noted that contents of a binary 800 before patching a vulnerability and a binary 820 after patching a vulnerability may be described in the form of assembly code in FIG. 5 for convenience of understanding, but may be actually written in the form of machine language (machine code). It is noted that assembly codes shown in FIG. 8 do not correspond to the example codes shown in FIG. 7.

The binary 800 before patching a vulnerability in FIG. 8 includes an instruction 811 to read data from a memory address corresponding to a value stored in a register ‘eax’ and store it in the register ‘eax’ (mov (% eax), % eax). It is noted that the instruction is written at an address of 0x0804895a in the binary 800 before patching the vulnerability. For purposes of explanation, it is assumed that the instruction 811 has been identified as having a possibility of causing a crash due to the reference of a null pointer in a process of vulnerability search and cause analysis.

In the binary 820 after patching the vulnerability in FIG. 8, an instruction 811 that may cause the crash (mov (% eax), % eax) may be replaced with a first jump instruction 831. In other words, the first jump instruction 831 to jump to a patch code block 840 is written at the address of 0x0804895a of the binary 820 after patching the vulnerability.

The patch code block 840 includes an instruction to verify a value of the register ‘eax’ used as an operand of an instruction accessing a memory. For example, the patch code block 840 includes an instruction 841 to determine whether the value of the register ‘eax’ is a NULL value. The patch code block 840 includes a second instruction 842 to moves a control flow to an instruction 844 based on the value of the register ‘eax’ not being a NULL value. In addition, based on the value of the register ‘eax’ being a NULL value, the patch code block 840 includes instructions 843 to output an error message (“[ERROR] null ptr”) and stop the execution of the binary 820 after patching the vulnerability.

In addition, the patch code block 840 includes an instruction 844 that directly copies the instructions 811 that may cause the crash (mov (% eax), % eax), and subsequently includes a third jump instruction 845 that jumps to an address where an instruction following the instruction 811 is written.

So far, instructions written in binaries before and after performing a patch that removes a vulnerability due to the reference of a null pointer have been described by the method according to some other embodiments of the present disclosure. Hereinafter, an execution flow of the binary 820 after patching the vulnerability will be described.

Based on the ‘foo2’ function being called in the binary 820 after patching the vulnerability first, the control flow moves to a block 830. The first jump instruction 831 is executed that is written in place of the instructions 811 that have the potential to cause a crash due to the reference of a null pointer (mov (% eax), % eax). The control flow is moved to the patch code block 840 by the first jump instruction 831.

The instruction 841 is an instruction to determining whether the value of the register ‘eax’ used as an operand of an instruction for accessing a memory is a NULL value, as described above. Based on the value of the register ‘eax’ not being a NULL value, the control flow is moved to the instruction 844 by the second jump instruction 842.

The instruction 844 is an instruction that copies the instruction 811 having the possibility of causing a crash due to the reference of a null pointer (mov (% eax), % eax), as it is. However, since it has already been determined that the value of the register ‘eax’ is not a NULL value, a crash due to the reference of the null pointer will not occur even based on the instruction 844 being executed. After the instruction 844 is executed, by the third jump instruction 845, the control flow is moved back to the next address of the instruction 831 of the block 830.

On the other hand, as a result of executing the instruction 841 to determine whether the value of the register ‘eax’ is a NULL value, based on it being determined that the value of the register ‘eax’ is a NULL value, the instruction (mov (% eax), % eax) will cause a crash. The instructions 843 to output an error message (“[ERROR] null ptr”) and stop execution of the binary 820 after patching the vulnerability may be executed.

So far, referring to FIG. 8, the exemplary method for performing the patch that removes a vulnerability due to the reference of the null pointer has been described by the method according to some other embodiments of the present disclosure. However, it may be understood that the exemplary method as described so far may be applied to patch other vulnerabilities caused by abnormal memory access (e.g., buffer over-write, buffer under-write, buffer over-read, buffer under-read, etc.). For example, by selecting the instructions 841 written to verify whether abnormal memory access occurs in the binary 820 after patching the vulnerability shown in FIG. 8, it may also be used to remove other vulnerabilities (e.g., buffer over-write, buffer under-write, buffer over-read, buffer under-read, etc.).

Hereinafter, a device for patching a vulnerability of a binary according to another embodiment of the present disclosure will be described with reference to FIG. 9. In analyzing the configuration and operation of the device for patching the vulnerability of the binary according to the present embodiment, the description of the method for patching the vulnerability of the binary according to some embodiments of the present disclosure described with reference to FIGS. 2 to 8 may be reflected.

A device for patching the vulnerability of the binary 900 according to the present embodiment may include a binary analysis unit 910, a patch area generation unit 920, and a patch execution unit 930. The device for patching the vulnerability of the binary 900 receives a target binary 10 having a vulnerability, removes the vulnerability, and outputs the binary 20 to which the patch to remove the vulnerability is applied. Although not shown, in some embodiments, information on the vulnerability found in the target binary 10 may also be provided as an input to the device for patching 900. The information on the vulnerability may include the type of vulnerability and an address of an area where the vulnerability occurred. The information on the vulnerability may be provided as a result of performing the process of searching 110 for the vulnerability and the process of analyzing 120 the cause of the vulnerability as shown in, for example, FIG. 1.

The binary analysis unit 910 may disassemble the target binary 10 to calculate assembly code. In addition, the binary analysis unit 910 may receive information on the vulnerability found in the target binary 10, and identify an address of an area where the vulnerability occurred or a function where the vulnerability occurred. In addition, the binary analysis unit 910 may identify an address in which a prologue is written, by searching the prologue of the function in which the vulnerability occurred, from the assembly code for the target binary 10. The binary analysis unit 910 may provide the assembly code and the information on the vulnerability to the patch area generation unit 920 and the patch execution unit 930.

The patch area generation unit 920 may secure an area in which patch code is to be inserted in the target binary 10. The patch area generation unit 920 may determine the area in which the patch code is to be inserted by searching for a free space having a size sufficient to insert the patch code in the target binary 10. Here, the patch area generation unit 920 may identify a space filled with an NOP instruction in a code section (.text) in the target binary 10 as the free space. On the other hand, based on the free space having the size sufficient to insert the patch code in the target binary 10 not being found, the patch area generation unit 920 may generate an additional area in the target binary 10, and may modify a program header or section header corresponding to a segment or section in which the additional area is generated, in the file of the target binary 10, so as to reflect the generation of the additional area. The patch area generation unit 920 may provide the patch execution unit 930 with information (e.g., an address and size of the area) on the area in which the patch code is to be inserted in the target binary 10.

The patch execution unit 930 may automatically generate patch code based on the information on the vulnerability. Here, the patch code may be automatically generated in the form of machine code, or automatically generated in the form of assembly code and then converted into machine code.

The patch code includes instructions to remove or resolve the vulnerability found in the target binary 10. For example, based on the vulnerability found in the target binary 10 being a vulnerability due to the use of an uninitialized variable, the instructions may include instructions to initialize a stack frame of a function using an uninitialized variable. As another example, based on the vulnerability found in the target binary 10 being a vulnerability due to the reference of a null pointer, the instructions may include an instruction to determine a value stored in a register used as an operand of an instruction that access a memory, and an instruction to output an appropriate error message based on a value stored in the register being a null value. As another example, based on the vulnerability found in the target binary 10 being a vulnerability due to buffer overwrite, the instructions may include an instruction to determine a value stored in a register that may be likely to be used to access an area beyond a memory range allocated to a buffer.

In addition, the patch code may include a jump instruction after instructions to remove or resolve the vulnerability. The jump instruction is an instruction to move a control flow to an area where the vulnerability is found in the target binary 10. For example, the jump instruction includes an instruction to jump to a next address of the last instruction in the area where the vulnerability is found.

The patch execution unit 930 may insert the patch code into an area in the target binary 10 identified by the patch area generation unit 920. For example, the patch execution unit 930 may write the patch code in the form of machine code in the address of the area where the patch code is to be inserted in the target binary 10.

In addition, the patch execution unit 930 may replace at least some instructions in the area in which the vulnerability of the target binary 10 occurs, with an instruction to jump to the patch code block. For example, the patch execution unit 930 may write the instruction to jump to the patch code block at an address in which the at least some instructions in the area in which the vulnerability occurred in the target binary 10 may be written. Here, based on a size of a space used for writing the jump instruction being smaller than a size of a space where the replaced some instructions may be written, an appropriate number of NOP instructions may be additionally written. Due to the writing of the NOP instruction, it is possible to prevent a malfunction during execution of the patched binary while minimizing the modification or rewriting of the target binary 10.

Also, the patch execution unit 930 may store the binary 20 to which the patch is applied to the target binary 10 or transmit it to another computing device through a network.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

In the above description, it is described that all the components constituting the embodiments of the present disclosure are combined or operated as one, but the technical features of the present disclosure are not limited to these embodiments. That is, within the scope of the present disclosure, all of the components may be selectively combined and operated in one or more combinations.

Although the operations are shown in an order in the drawings, those skilled in the art will appreciate that many variations and modifications can be made to the embodiments without substantially departing from the principles of the present disclosure. The disclosed embodiments of the present disclosure are used in a generic and descriptive sense and not for purposes of limitation. The scope of protection of the present disclosure should be interpreted by the following claims, and all technical ideas within the scope equivalent thereto should be construed as being included in the scope of the technical idea defined by the present disclosure.

What is claimed is:

1. A method for patching a vulnerability of a binary, the method being performed on a computing device, and comprising:
inserting a patch code block in a target binary; and
replacing at least some instructions in an area where the vulnerability exists in the target binary with a first instruction to jump to the patch code block,
wherein the patch code block comprises:
a second instruction to resolve the vulnerability; and
a third instruction to jump to a fourth instruction next to the first instruction replaced in the area where the vulnerability exists.

2. The method of claim 1, wherein the at least some instructions being replaced are instructions of a prologue of a function including the area where the vulnerability exists,
wherein the patch code block further comprises:
one of the instructions of the prologue of the function; and
a fifth instruction to initialize a stack frame of the function.

3. The method of claim 2, wherein the fifth instruction to initialize the stack frame comprises a sixth instruction to initialize data of the stack frame, the stack frame being identified by a value of a stack pointer register and a value of a base pointer register.

4. The method of claim 1, wherein a size of the target binary does not change by the insertion of the patch code block.

5. The method of claim 4, wherein inserting the patch code block comprises:
searching for a free area among text areas of the target binary; and
writing the patch code block within the free area.

6. The method of claim 1, wherein inserting the patch code block comprises:
adding an area for the patch code block to the target binary, and writing the patch code block within the added area.

7. The method of claim 6, wherein inserting the patch code block comprises:
searching for a free area among text areas of the target binary;
comparing a size of the free area with a size of the patch code block; and
in response to determining that the size of the free area is less than the size of the patch code block, adding an area for the patch code block to the target binary, and writing the patch code block in the added area.

8. A method for patching a vulnerability of a binary, the method being performed on a computing device, and comprising:
inserting a patch code block in a target binary; and
replacing at least some instructions in an area where the vulnerability exists in the target binary with a first instruction to jump to the patch code block,
wherein the patch code block comprises a second instruction to determine whether a crash occurs at runtime.

9. The method of claim 8, wherein the patch code block comprises:
a third instruction to stop execution of the target binary in response to determining that a crash occurs at runtime; and
a fourth instruction to jump to a fifth instruction next to the first instruction replaced in the area where the vulnerability exists in response to determining that the crash does not occur at runtime.

10. The method of claim 9, wherein the crash comprises a crash due to abnormal memory access, and
wherein the second instruction to determine comprises a sixth instruction to determine an execution flow of the binary based on a value of a register used as an operand of a seventh instruction that accesses a memory among at least some instructions in the area where the vulnerability exists.

11. The method of claim 10, wherein the abnormal memory access comprises at least one of null pointer use, buffer over-write, and buffer under-write.

12. The method of claim 8, wherein inserting the patch code block comprises:
searching for a free area among text areas of the target binary; and
writing the patch code block within the free area.

13. The method of claim 8, wherein inserting the patch code block comprises adding an area for the patch code block to the target binary, and writing the patch code block within the added area.

14. A device for patching a vulnerability of a binary, comprising:
a patch area generation unit; and
a patch execution unit,
wherein the patch area generation unit is configured to:
search for a free area among text areas of a target binary;
add an area for a patch code to the target binary based on a size of the free area being less than a size of the patch code; and
determine a patch area into which the patch code is to be inserted in the target binary,
wherein patch execution unit is configured to:
insert the patch code in the patch area; and
replace at least some instructions in an area where the vulnerability exists in the target binary with a first instruction to jump to the patch area,
wherein the patch code comprises:
a second instruction to resolve the vulnerability; and
a third instruction to jump to a fourth instruction next to the first instruction replaced in the area where the vulnerability exists.
